(19) United States
(12) Patent Application Publication
(10) Pub. No.: US 2012/0086546 A1
(43) Pub. Date: Apr. 12, 2012

(54) SYSTEM AND METHOD FOR CONTROLLING ACCESS TO A SOURCE OF ELECTRICAL POWER

(76) Inventors: Steven Montgomery, Kitchener (CA); Nicolas Jones, Kitchener (CA)

(21) Appl. No.: 13/269,431

(22) Filed: Oct. 7, 2011

Related U.S. Application Data
(60) Provisional application No. 61/390,677, filed on Oct. 7, 2010.

(51) Int. Cl. G06F 7/04

(52) U.S. Cl. 340/5.1

(57) ABSTRACT

A system for controlling access to a source of electrical power. The system includes a readable access information device with access information that is associated with an electrical load device electrically connectable to a receptacle, a switch device for connecting and disconnecting the receptacle to and from the source of electrical power, and a reader for reading the access information from the readable access information device, and determining whether preselected criteria are satisfied by the access information. If the preselected criteria are satisfied, the receptacle is connected to the source of electrical power, and the electrical load device is connectable to the source of electrical power via the receptacle. If any one or more of the preselected criteria are unsatisfied, then the receptacle is disconnected from the source of electrical power.

This application claims the benefit of U.S. Provisional Patent Application No. 61/390,677, filed Oct. 7, 2010, and incorporates such provisional application in its entirety by reference.

### FIELD OF THE INVENTION

This invention is related to a system and a method for controlling access to a source of electrical power.

### BACKGROUND OF THE INVENTION

Electric receptacles, through which a source of electrical power is accessible, typically are located in various areas that are open to the public (e.g., airport lobbies and waiting rooms, bus terminals, hotel lobbies). For a variety of reasons, the owner/operator of the premises in which the public area is located may wish to limit access to the source of electrical power to those who are authorized. However, in the prior art, the means for limiting access are generally somewhat inflexible.

For instance, in one typical arrangement, where it is intended that only certain authorized parties (e.g., janitorial staff) have access to electricity via the electric receptacles in the public area, the connection of the receptacles to the source of electrical power is controlled by a manually operated switch, and only those parties are able to operate the switch. Conventionally, the manually operated switch may be secured by a mechanical lock. However, this arrangement has some disadvantages. For example, the switch is only available if one of the authorized parties has an appropriate key for the mechanical lock, which may or may not be convenient. Also, once the receptacles are energized, any member of the public in the public area where the receptacles are located may utilize the electricity available via the receptacles, subject only to interdiction by the authorized parties.

### SUMMARY OF THE INVENTION

For the foregoing reasons, there is a need for a system and method for controlling access to a source of electrical power that overcomes or mitigates one or more of the defects of the prior art.

In its broad aspect, the invention provides a system for controlling access to a source of electrical power, the system including a readable access information device associated with one or more electrical load devices electrically connectable one or more receptacles, the readable access information device including access information, and a switch device for connecting and disconnecting the receptacle to and from the source of electrical power. The system also includes a reader for reading the access information from the readable access information device, the reader being operably coupled with the switch device. Upon the reader reading the access information and determining that the access information satisfies preselected criteria, and if the receptacle is disconnected from the source of electrical power, the reader generates a connect signal that is transmitted to the switch device. Upon the switch device receiving the connect signal, the switch device connects the receptacle to the source of electrical power, to permit the electrical load device to connect to the source of electrical power via the receptacle. Upon the reader determining that one or more preselected criteria is unsatisfied by the access information while the receptacle is connected to the source of electrical power, the reader generates a disconnect signal that is transmitted to the switch device. Upon the switch device receiving the disconnect signal, the switch device disconnects the receptacle from the source of electrical power.

In another aspect, the reader reads the access information at predetermined time intervals to determine, at the predetermined time intervals, whether the access information satisfies the preselected criteria.

In another of its aspects, the access information includes time credit information.

In yet another aspect, the access information includes a unique address associated with the electrical load device.

In another of its aspects, the access information includes one or more group codes associated with the electrical load device.

In another aspect, the access information includes user identification information for authorizing connection of the receptacle to the source of electrical power for an authorized user.

In yet another aspect, the access information includes one or more preselected characteristics of electrical power provided by the source of electrical power.

In another aspect, the invention provides a system for controlling access to a source of electrical power, including a readable access information device associated with one or more electrical load devices, the readable access information device having access information, a switch device for connecting and disconnecting the electrical load device to and from the source of electrical power, and a reader for reading the access information from the readable access information device, the reader being operably coupled with the switch device. Upon the reader reading the access information and determining that the access information satisfies preselected criteria, and if the electrical load device is disconnected from the source of electrical power, the reader generates a connect signal that is transmitted to the switch device. Upon the switch device receiving the connect signal, the switch device connects the electrical load device to the source of electrical power. Upon the reader determining that one or more of the preselected criteria is unsatisfied by the access information while the electrical load device is connected to the source of electrical power, the reader generates a disconnect signal that is transmitted to the switch device. Upon the switch device receiving the disconnect signal, the switch device disconnects the electrical load device from the source of electrical power.

### BRIEF DESCRIPTION OF THE DRAWINGS

The invention will be better understood with reference to the attached drawings, in which:

FIG. 1 is a schematic diagram of an embodiment of the invention;

FIG. 2A is an isometric view of an embodiment of a plug of the invention including an embodiment of a readable access information device of the invention;

FIG. 2B is an exploded isometric view of the plug of FIG. 2A;

FIG. 3 is a front view of an embodiment of a card device of the invention including an embodiment of a readable access information device of the invention;

FIG. 4A is a front view of an embodiment of a receptacle of the invention, drawn at a larger scale;

FIG. 4B is an isometric view of an alternative embodiment of the receptacle of the invention, drawn at a smaller scale;

FIG. 4C is an isometric view of another alternative embodiment of the receptacle of the invention;

FIG. 5A is a schematic diagram of an alternative embodiment of the invention;

FIG. 5B is a schematic illustration of various parameters which may be included in access information in the readable access information devices of FIGS. 1 and 5A;

FIG. 6 is a flow chart schematically illustrating an embodiment of a method of the invention;

FIG. 7A is a flow chart schematically illustrating another embodiment of the method of the invention;

FIG. 7B is a flow chart schematically illustrating another embodiment of the method of the invention;

FIG. 8 is a flow chart schematically illustrating another alternative embodiment of the method of the invention;

FIG. 9 is a flow chart schematically illustrating another alternative embodiment of the method of the invention;

FIG. 10 is a flow chart schematically illustrating another alternative embodiment of the method of the invention; and

FIG. 11 is a flow chart schematically illustrating another alternative embodiment of the method of the invention.

### DETAILED DESCRIPTION

The present invention may be understood more readily by reference to the following detailed description of the invention and the examples provided herein. It is to be understood that the aspects described below are not limited to specific circuits, outlets, receptacles, plugs, or devices, and as such may vary. It is also to be understood that the terminology used herein is for the purpose of describing particular aspects only and is not intended to be limiting.

In this specification and in the claims that follow, reference will be made to a number of terms that shall be defined to have the following meanings.

About: Often, ranges are expressed herein as from “about” one particular value, and/or to “about” another particular value. When such a range is expressed, another embodiment includes from the one particular value and/or to the other particular value. Similarly, when values are expressed as approximations, by use of the antecedent “about”, it will be understood that the particular value forms another embodiment. It will be further understood that the endpoints of each of the ranges are significant both in relation to the other endpoint, and independently of the other endpoint.

Articles: As used in the specification and the appended claims, the singular forms “a”, “an” and “the” include plural references unless the context clearly dictates otherwise.

Command Card: A PCD tag in a format suitable for manual handling. Data contained therein is accessible by a PCD Reader.

Electrical Load Device: “Electrical load device” means any device which can be electrically connected in a circuit and which draws current or passes current. “Electrical load device” can include any component (e.g., such as a damaged extension cord) which, even if not activated, nonetheless can draw actual current.

Outlet: Electrical wiring device containing at least one receptacle. Provides a means for the quick connection and disconnection of an electrical device to an electrical distribution system. For example, the outlet could be an in-wall outlet or in an extension cord or a power strip.

PCD Reader: A device or circuit that can read and/or write data from/to a PCD tag.

PCD Tag: A device containing data that can provide access to that data to a PCD reader when in close proximity. Effectively, a contactless memory storage device.

Plug: A set of connector pins or blades that provides a means to connect an attached electrical load device to a source of electrical power by way of a compatible receptacle.

Programmable: A device, storage means or data value is “programmable” if it can be adjusted, configured or changed.

Receptacle: A set of connector sockets that provides a means to connect an electrical load device equipped with a compatible plug to a source of electrical power.

Switch Device: A means to connect and disconnect the path of an electrical circuit.

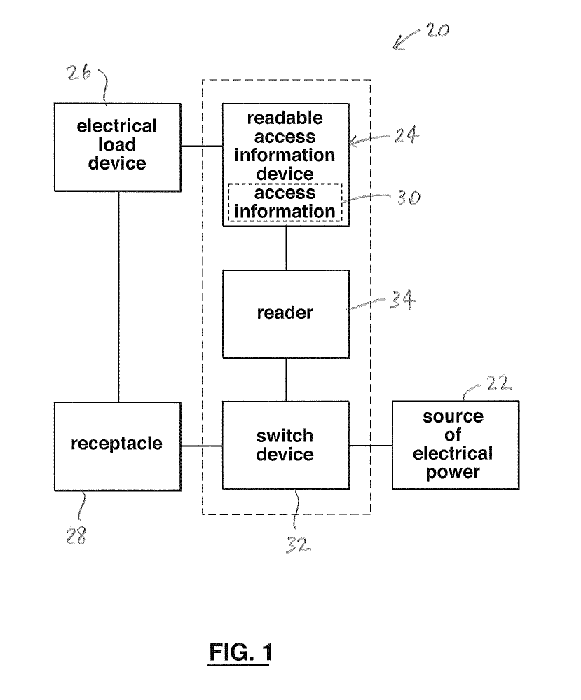

In the attached drawings, like reference numerals designate corresponding elements throughout. Reference is first made to FIG. 1 to describe an embodiment of a system in accordance with the invention indicated generally by the numeral 20. As will be described, the system 20 is for controlling access to a source of electrical power 22. In one embodiment, the system 20 preferably includes a readable access information device 24 associated with one or more electrical load devices 26 electrically connectable to one or more receptacles 28, the readable access information device including access information 30. Preferably, the system 20 also includes a switch device 32 for connecting and disconnecting the receptacle 28 to and from the source of electrical power 22. It is also preferred that the system 20 includes a reader 34 for reading the access information 30 from the readable access information device 24, the reader 34 being operably coupled with the switch device 32. Upon the reader reading the access information 30 and determining that the access information 30 satisfies all preselected criteria, and if the receptacle 28 is disconnected from the source of electrical power 22, it is preferred that the reader 34 generates a connect signal that is transmitted to the switch device 32. Also, upon the switch device 32 receiving the connect signal, the switch device 32 preferably connects the receptacle 28 to the source of electrical power 22, to permit the electrical load device 26 to connect to the source of electrical power 22 via the receptacle 28. Upon the reader 34 determining that any one of the preselected criteria is unsatisfied while the receptacle 28 is connected to the source of electrical power 22, the reader 34 preferably generates a disconnect signal that is transmitted to the switch device 32. Upon the switch device 32 receiving the disconnect signal, the switch device 32 preferably disconnects the receptacle 28 from the source of electrical power 22.

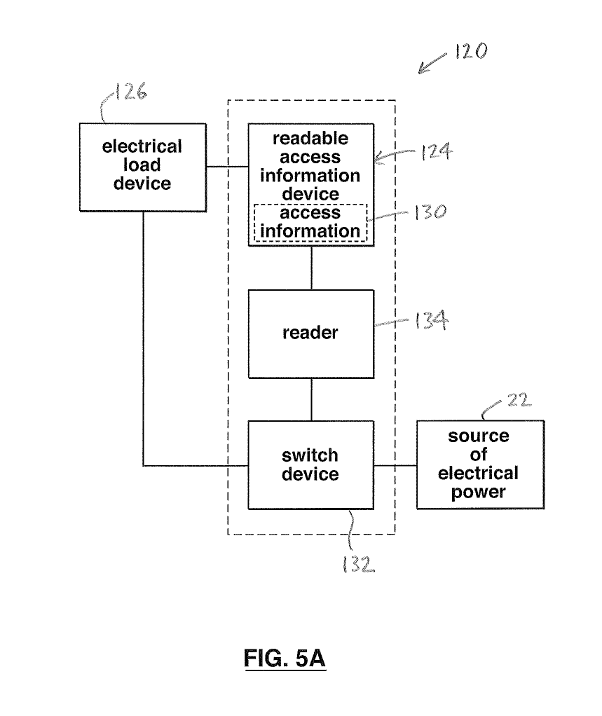

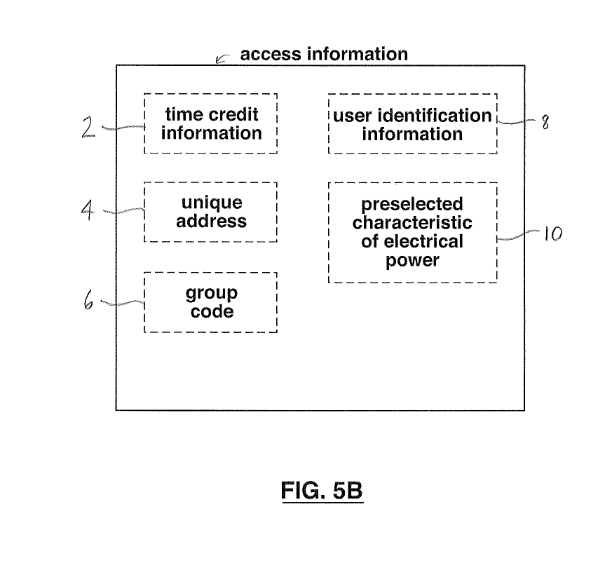

It will be appreciated by those skilled in the art that the access information may include information regarding any suitable parameters. For instance, the access information may include time credit information 2 (FIG. 5B), e.g., a preauthorized time period, paid for in advance by a user. Where the access information includes time credit information, in one embodiment, the user has paid to obtain, via a receptacle, access to the source of electrical power for up to a certain (preauthorized) time period. That is, the user who has purchased time credit information has purchased access to the source of electrical power, via a receptacle.

Alternatively, or in addition to the time credit information, the access information may include unique address information 4 (FIG. 5B), e.g., information identifying the electrical load device with which the access information is associated. Examples of the operation of the system where the access information includes these parameters, and certain other parameters, are described below.

Preferably, the preselected criteria are any suitable criteria. The preselected criteria in any particular application are determined according to the parameters utilized in the access information 30. For instance, where the access information 30 includes time credit information, the preselected criteria would include one or more criteria related to the time credit information. In this example, one such preselected criterion would be that there is a certain time period that is preauthorized (i.e., paid for in advance), according to the time credit information.

It will be understood that, when the reader determines whether the access information satisfies the preselected criteria, such criteria are only considered satisfied if all the preselected criteria are satisfied. Also, if any one of the preselected criteria is unsatisfied, then the preselected criteria are considered to be unsatisfied. In addition, it will be understood that, if the reader cannot read some or all of the access information, then the relevant preselected criteria are considered to be unsatisfied. That is, a lack of access information results in the preselected criteria being unsatisfied.

In one embodiment, another type of preselected criterion preferably is a group (or facility, or venue) code 6 (FIG. 5B). This preselected criterion is used to confirm that the electrical load device with which the readable access information device is associated is included in a group that the reader is programmed to accept. (It will also be understood that, alternatively, a number of group codes may be authorized at any reader.) For instance, the user may purchase time credits (i.e., add time credit information to the access information in his readable access information device) in a particular venue, e.g., an airport. It will be appreciated by those skilled in the art that, in this example, the readable access information device 24 is conveniently located in a command card 38, physically separate from the electrical load device. The command card 38 may be a preprogrammed card purchased from the vendor. In this case, the card's access information preferably includes time credit information providing for a preauthorized time period. Additionally, the access information preferably includes a group code, indicating that the time credits were purchased from a particular vendor. Alternatively, the command card may be a device owned by the customer but programmable by the vendor at point of purchase, e.g., to add time credits, and also to add an indication (i.e., the group code) that the time credits were purchased from a particular vendor.

In these circumstances, when the reader at a receptacle in the airport reads the access information, it is programmed to read the group code, and the time credit information. In this example, if the group code matches the group code that is required (or one of a number of preauthorized group codes, as the case may be), and if the time credit information satisfies the preselected criterion therefor, then all the preselected criteria are satisfied. If the receptacle is disconnected, then the connect signal is generated and transmitted, so that the receptacle is then connected to the source of electrical power 22.

However, in this example, if the user purchases the time credit information at a venue other than the airport, then the access information does not include the correct group code, if the user wishes to access the source of electrical power via a receptacle at the airport. In this case, when the reader reads the access information, the reader will determine that one of the preselected criteria (namely, a requirement that the access information includes a group code matching one or more preauthorized group codes in the reader's memory, e.g., a group code showing that the time credit was purchased at the airport) is not satisfied. As will be discussed below, if any one of the preselected criteria is unsatisfied, and if the receptacle is disconnected from the source of electrical power, then the receptacle remains disconnected. In this way, the owner/manager of the public area in which the receptacle(s) is located restricts access to the source of electrical power via the receptacle(s) to the users who purchased time credits at that venue.

The group code may be company-based, rather than location-based. For instance, a number of franchisees operating retail businesses (e.g., coffee shops) may offer time credits. When the user purchases time credits at one of the franchised retail businesses, the group code is added to the access information. Preferably, the group code satisfies the preselected criterion therefor at the receptacles (i.e., the readers) at any of the franchise chain's retail businesses, notwithstanding that the time credits may have been purchased at a different franchise business location.

Those skilled in the art will appreciate that the access information may contain such data related to selected parameters as is desired, and the reader may be programmed to read any such data, and to determine (by comparison to data in the reader's memory) whether the preselected criteria related to the selected parameters are satisfied by the data in the access information. For instance, and as will be described, in addition to the other parameters referred to above, the access information may include user identification information 8 and/or one or more preselected characteristics 10 of the electrical power provided by the source of electrical power. It will be understood that the parameters schematically illustrated in FIG. 5B are exemplary only. In any particular configuration, the access information may contain data related to other parameters (not shown in FIG. 5B), or the access information may contain data related to any one or more of the parameters referred to in FIG. 5B.

Those skilled in the art will also appreciate that the reader 34 preferably reads the access information 30 in any suitable manner, and that there is a wide variety of methods and means that are suitable. For instance, the methods of reading the access information may include magnetic, RFID (i.e., PCD tags and readers), wireless radio, serial digital data, and parallel digital data. For the purposes of description herein, the system 20 including PCD tags read by PCD readers will be described. However, it will be understood that the system 20 may include any suitable method or means of storing the access information in the readable access information device, and any suitable method or means of reading the access information.

PCD tags and PCD readers are described in U.S. Pat. No. 8,000,074, the entire specification and drawings of which are hereby incorporated herein by reference. Accordingly, a detailed description of the operation of the PCD tag and the PCD reader is unnecessary.

As noted above, it is preferred that the readable access information device 24 (and the access information 30) is associated with the electrical load device 26. In this context, “associated” means identified with, or related to. For instance, the electrical load device 26 may be a charging device, for charging a battery in a handheld device (not shown). Alternatively, the electrical load device may be a laptop computer or similar device (not shown). In one embodiment, the access information in or on the readable access information device 24 preferably includes time credit information, i.e., when read, the time credit information indicates that connection to the source of electrical power is authorized for a certain time period, which is prepaid, or authorized on some other basis.

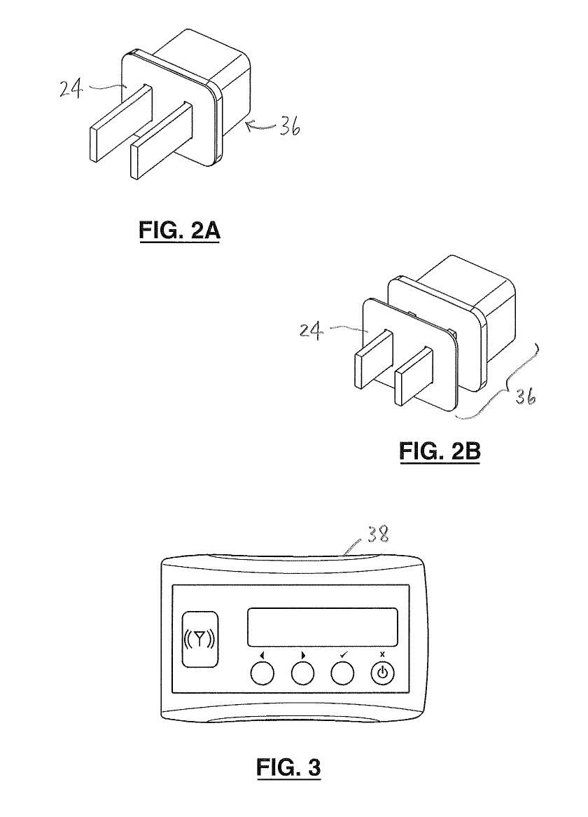

Those skilled in the art will appreciate that the readable access information device 24 may be associated with the electrical load device 26 in any suitable manner. For example, and as will be described, the readable access information device 24 may be physically connected to, or included in, a plug 36 (FIGS. 2A, 2B), which is physically connected to the electrical load device 26, i.e., via a power cord, in conventional manner (not shown in FIGS. 2A, 2B). Alternatively, the readable access information device 24 may be included in an element 38 (i.e., a command card) that is not physically connected or attached to the electrical load device 26 (not shown in FIG. 3). Such element 38 preferably is in the form of a card, but may be in any other suitable form, e.g., a key fob.

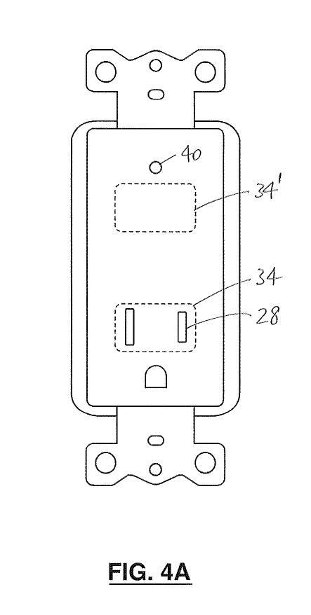

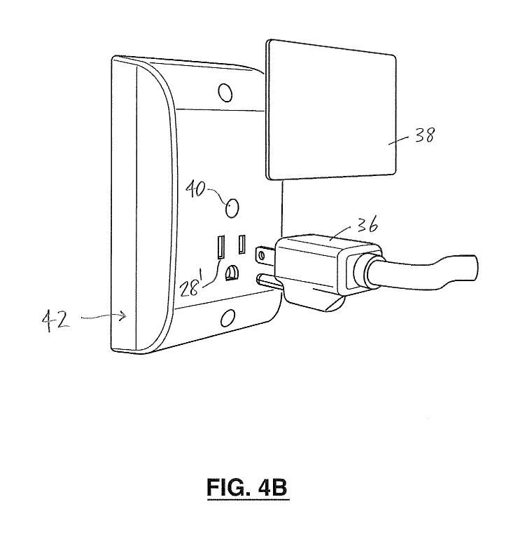

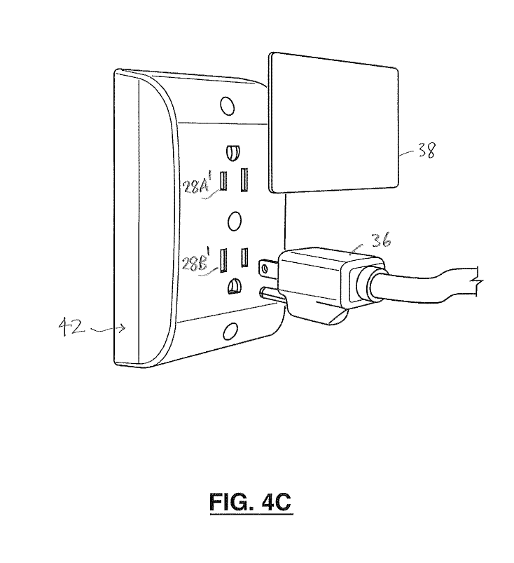

As noted above, the reader 34 is operably coupled with the switch device 32. The switch device 32 preferably is any suitable relay or switch which is adapted to receive signals from the reader. Preferably, the reader 34 is positioned proximal to the switch device 32, which in turn preferably is also positioned proximal to the receptacle 28. An embodiment of the receptacle 28, with the location of the reader 34 positioned proximal thereto, is illustrated in FIG. 4A. An alternative location of the reader 34′ is also indicated in FIG. 4A.

An outlet 42, for use as a retrofit application, is illustrated in FIG. 4B. The outlet 42 includes a receptacle 28′, and preferably includes a plug portion (not shown) which enables the outlet 42 to connect to the source of electrical power 22 via a conventional receptacle (not shown). Preferably, the outlet 42 includes the reader 34 (not shown in FIG. 4B) for reading the access information stored on the readable access information device 24 in the element 38. The plug 36 is receivable in the receptacle 28′ in the outlet 42. An alternative embodiment of the outlet 42, including two receptacles 28A′ and 28B′, is illustrated in FIG. 4C.

Those skilled in the art would also appreciate that the access information preferably is encrypted, using any suitable type of encryption (e.g., public key cryptography), to discourage illicit utilization of electricity by unauthorized parties.

It will be appreciated by those skilled in the art that the invention preferably is implemented using any suitable hardware and software. For example, if PCD tags and PCD readers are utilized, then commercially available microprocessors, RFID reader chips, and RFID transponder chips may be used.

An unauthorized user may attempt to obtain illicit (i.e., unauthorized) access to the source of electrical power by, for example, removing the plug of a properly authorized electrical load device from a receptacle, and replacing that plug with the plug of an unauthorized electrical load device. In this way, the unauthorized user may attempt to utilize the access to the source of electrical power that an authorized user has paid for. Preferably, this possibility is addressed by the reader 34 reading the access information 30 at predetermined time intervals, because when the reader reads the access information, the reader also determines whether all of the preselected criteria are satisfied by the access information. In effect, when the reader reads the access information at the predetermined time intervals, the reader is checking, at the predetermined time intervals, whether the access information satisfies the preselected criteria.

In one embodiment, the reader 34 preferably reads the access information 30 at predetermined time intervals to determine, at the predetermined time intervals, whether the access information 30 satisfies one or more of the preselected criteria. Upon the reader 34 determining that the access information 30 satisfies all preselected criteria, and if the receptacle 28 is disconnected from the source of electrical power 22, the reader 34 generates the connect signal, which is transmitted to the switch device 32 for connection of the receptacle 28 to the source of electrical power 22. However, upon the reader 34 determining that one or more of the preselected criteria are unsatisfied by the access information 30 while the receptacle 28 is connected to the source of electrical power 22, the reader 34 generates the disconnect signal, which is transmitted to the switch device 32 for disconnection of the receptacle 28 from the source of electrical power 22.

The predetermined time interval may be any suitable time interval, and varies according to the application, and in particular varies depending on the type of access information which is stored and read. Preferably, the predetermined time interval is less than about 1 second, e.g., about 0.067 second.

For instance, in the example set out above, one preselected criterion that is checked is whether the readable access information device 24, with the time credit information and other information contained therein that had authorized the current connection of the receptacle 28 to the source of electrical power, is still readable by the reader 34. If the access information 30 in such readable access information device 24 is not readable for whatever reason (e.g., if the readable access information device 24 was removed), then at least one of the preselected criteria is considered to be unsatisfied, and the reader generates the disconnect signal, resulting in the receptacle 28 being disconnected from the source of electrical power 22, as described above.

As noted above, in this example, the preselected criteria includes at least one preselected criterion in respect of the time credit information. The time credit information may include, for example, a preauthorized time period. The preselected criterion in respect of the time credit information is that there is a preauthorized time period, i.e., data in readable form confirming this. If it is determined in this example, initially, that the time credit information does not include data confirming a preauthorized time period, then at least one of the preselected criteria has not been satisfied. In this situation (i.e., if the receptacle 28 is disconnected from the source of electrical power 22, and any one of the preselected criteria is unsatisfied), then no signal is generated by the reader 34 for transmission to the switch device 32.

Those skilled in the art will appreciate that, in general, if any one of the preselected criteria is not satisfied by the access information 30, and if the receptacle is disconnected from the source of electrical power 22, then no signal is generated by the reader for transmission to the switch device, i.e., the receptacle remains disconnected. In an alternative embodiment, if any one of the preselected criteria is unsatisfied by the access information 30, and if the receptacle is disconnected from the source of electrical power, the reader generates a “non-connect” signal, which is transmitted to the switch device, resulting in the switch device not connecting the receptacle to the source of electrical power, i.e., the receptacle remains disconnected. The preselected criteria may be unsatisfied, for instance, if there is readable data in the access information 30 indicating that no preauthorized time period remains unused. As noted above, a lack of readable access information (i.e., for any data required to be read by the reader, for determining satisfaction or otherwise of any of the preselected criteria) also results in the preselected criteria being considered to be unsatisfied.

As described above, if all of the preselected criteria are satisfied by the access information 30, and if the receptacle is disconnected from the source of electrical power, then the reader generates the connect signal, which is transmitted to the switch device, and the switch device connects the receptacle to the source of electrical power. In one embodiment, if the receptacle is connected to the source of electrical power and the reader determines that all the preselected criteria are satisfied by the access information, then no signal is transmitted by the reader to the switch device, i.e., the receptacle remains connected. In an alternative embodiment, if the receptacle is connected to the source of electrical power and the reader determines that all of the preselected criteria are satisfied by the access information, the reader generates a “non-disconnect” signal, which is transmitted to the switch device, causing the switch device to keep the receptacle connected to the source of electrical power, i.e., the receptacle remains connected.

As another example, where the access information 30 preferably includes time credit information, upon the reader 34 determining that the time credit information satisfies one or more preselected criteria in respect thereof (and all preselected criteria are otherwise satisfied), and if the receptacle 28 is disconnected from the source of electrical power 22, the reader 34 generates the connect signal, which is transmitted to the switch device 32 for connection of the receptacle 28 to the source of electrical power 22. Also, upon the reader 34 determining that one or more of the preselected criteria (including those in respect of the time credit information) are unsatisfied by the time credit information while the receptacle 28 is connected to the source of electrical power 22, the reader 34 generates the disconnect signal, which is transmitted to the switch device 32 for disconnection of the receptacle 28 from the source of electrical power 22. Preferably, and as described above, the reader 34 reads the access information 30 (in this example, including time credit information) at predetermined time intervals, to determine at such time intervals whether the access information satisfies the preselected criteria.

The predetermined time interval is any suitable time interval. For example, where the access information 30 includes time credit information, it is preferred that the predetermined time interval is less than about one second.

As described above, it is preferred that the time credit information authorizes connecting the receptacle 28 to the source of electrical power 22 for up to a preauthorized time period while the preselected criteria are satisfied. Preferably, the reader 34 decrements the time credit information in preselected time decrement intervals while the receptacle 28 is connected to the source of electrical power 22, to decrease the preauthorized time period by the decremented time decrement intervals.

The manner in which the preauthorized time period is decremented in time decrement intervals is well known in the art, and therefore a detailed description of the process of decrementing is unnecessary. From the foregoing, it can be seen that, after the source of electrical power 22 has been connected for a certain period of time, during which period decrementing took place, the time credit information preferably includes a reduced preauthorized time period, i.e., the initial preauthorized time period as reduced by the decremented time intervals.

In another embodiment, where the access information 30 preferably includes time credit information, upon the reader 34 determining that the time credit information and any and all other access information satisfies the preselected criteria, and if the receptacle 28 is disconnected from the source of electrical power, the reader 34 generates the connect signal, which is transmitted to the switch device for connection of the receptacle 28 to the source of electrical power 22 for up to a preauthorized time period provided in the time credit information. Upon the reader 34 determining that one or more of the preselected criteria (including those in respect of the time credit information) is unsatisfied while the receptacle 28 is connected to the source of electrical power 22, the reader 34 generates the disconnect signal, which is transmitted to the switch device 32 for disconnection of the receptacle 28 from the source of electrical power 22.

In one embodiment, the access information 30 preferably includes time credit information for authorizing connection of the receptacle 28 to the source of electrical power 22 for up to a preauthorized time period. Upon the reader 34 determining that the time credit information satisfies one or more preselected criteria in respect thereof (and all other preselected criteria are otherwise satisfied), and if the receptacle 28 is disconnected from the source of electrical power 22, the reader 34 generates the connect signal, which is transmitted to the switch device 32 for connection of the receptacle 28 to the source of electrical power 22 for up to the preauthorized time period. As described above, while the receptacle 28 is connected to the source of electrical power 22, the reader 34 decrements the preauthorized time period in preselected time decrement intervals, to decrease the preauthorized time period by the decremented time decrement intervals. Upon the expiry of the preauthorized time period while the receptacle 28 is connected to the source of electrical power 22, the reader 34 determines that one or more of the preselected criteria in respect of the time credit information is unsatisfied, and the reader 34 generates the disconnect signal, which is transmitted to the switch device 32 for disconnection of the receptacle 28 from the source of electrical power 22.

In certain circumstances (discussed further below), it is advantageous to identify a particular electrical load device (or a number of electrical load devices, as the case may be) by a unique address therefor. One of the preselected criteria is that the unique address read by the reader matches a unique address in the reader's memory.

In another embodiment, the access information preferably includes a unique address associated with one or more electrical load devices. Preferably, the reader 34 reads the access information 30 at predetermined time intervals. Upon the reader 34 determining that the unique address satisfies one or more preselected criteria in respect thereof (and all other preselected criteria are otherwise satisfied), and if the receptacle 28 is disconnected from the source of electrical power 22, the reader 34 generates the connect signal, which is transmitted to the switch device 32 for connection of the receptacle 28 to the source of electrical power 22. Upon the reader 34 determining that one or more of the preselected criteria (including those in respect of the unique address) is unsatisfied in respect of the unique address while the receptacle 28 is connected to the source of electrical power 22, the reader 34 generates the disconnect signal, which is transmitted to the switch device 32 for disconnection of the receptacle 28 from the source of electrical power 22.

It will be appreciated that the frequent reading of the access information (i.e., at predetermined time intervals) provides security, to an extent, to the authorized user. For instance, if the predetermined time interval is set at less than about one second, then an unauthorized user (i.e., one who removes a plug for an electrical load device that is properly authorized, and inserts his (unauthorized) plug into that receptacle in an attempt to be connected to the source of electrical power 22) can only enjoy an unauthorized connection to the source of electrical power 22 for a maximum of the predetermined time interval, i.e., in this example, a time period that is less than about one second.

In an alternative embodiment, the access information 30 comprises one or more group codes associated with the electrical load device 26. Upon the reader 34 determining that one or more of the group codes satisfies one or more of preselected criteria in respect thereof (and all other preselected criteria are otherwise satisfied), and if the receptacle 28 is disconnected from the source of electrical power 22, the reader 34 generates the connect signal, which is transmitted to the switch device 32 for connection of the receptacle 28 to the source of electrical power 22. Upon the reader 34 determining that one or more of the preselected criteria is unsatisfied (including those in respect of the group code(s)) while the receptacle 28 is connected to the source of electrical power 22, the reader 34 generates the disconnect signal, which is transmitted to the switch device 32 for disconnection of the receptacle 28 from the source of electrical power 22.

It may be desirable to provide certain users with unfettered access to the source of electrical power, via the receptacles. In order to accommodate this, in one embodiment, the access information 30 preferably includes user identification information, to permit the reader to authorize access to the source of electrical power 22 for an authorized user upon the reader 34 detecting the user identification information in the access information 30. In this case, one of the preselected criteria is that the user identification information matches user identification information in the reader's memory.

In one embodiment, the access information 30 preferably includes user identification information for authorizing connection of the receptacle 28 to the source of electrical power 22 for the authorized user. Upon the reader 34 determining that the user identification information satisfies one or more preselected criteria in respect thereof (and all other preselected criteria are otherwise satisfied), and if the receptacle 28 is disconnected from the source of electrical power 22, the reader 34 generates the connect signal, which is transmitted to the switch device 32 for connection of the receptacle 28 to the source of electrical power 22. Upon the reader 34 determining that one or more of the preselected criteria (including those in respect of the user identification information) is unsatisfied while the receptacle 28 is connected to the source of electrical power 22, the reader 34 generates the disconnect signal and transmits the disconnect signal to the switch device 32 for disconnection of the receptacle 28 from the source of electrical power 22.

In this situation as well, it is advantageous to have the reader reading the access information (i.e., checking the user identification information) at predetermined time intervals, e.g., of 30 seconds each. In this way, the unauthorized user who attempts to take advantage of the authorized user's connection (e.g., by removing the authorized user's plug, and replacing it with the unauthorized user's plug) would be detected relatively rapidly, resulting in a prompt disconnection of the receptacle from the source of electrical power.

In another embodiment, the access information 30 preferably includes one or more preselected characteristics of electrical power provided by the source of electrical power 22. Preferably, the reader 34 reads the access information 30 at predetermined time intervals. Upon the reader determining that the preselected characteristic(s) satisfies one or more preselected criteria in respect thereof (and all preselected criteria are otherwise satisfied), and if the receptacle 28 is disconnected from the source of electrical power 22, the reader 34 generates and transmits the connect signal for connection of the receptacle 28 to the source of electrical power 22. Upon the reader 34 determining that one or more of the preselected criteria (including those in respect of the preselected characteristic of electrical power) is unsatisfied while the receptacle 28 is connected to the source of electrical power 22, the reader 34 generates the disconnect signal and transmits the disconnect signal to the switch device 32 for disconnection of the receptacle 28 from the source of electrical power 22.

Those skilled in the art will appreciate that the preselected characteristic(s) may be any suitable characteristic(s) of the electrical power. In one embodiment, the preselected characteristic is a line voltage associated with the electrical power provided by the source of electrical power at said at least one receptacle.

Preferably, where the access information includes line voltage, the reader checks the line voltage at relatively short predetermined time intervals. In this way, any significant problems with line voltage can be detected relatively promptly, minimizing the possibility of damage to the electrical load device.

It will be understood that, in another embodiment, the system 120 of the invention is for controlling access of an electrical load device 126 to the source of electrical power 22. The electrical load device 126 is directly connectable to the source of electrical power 22, i.e., such connection is not made via a receptacle. As can be seen in FIG. 5A, the system 120 preferably includes a readable access information device 124 associated with one or more electrical load devices 126, the readable access information device 124 including access information 130. It is preferred that the system 120 includes a switch device 132 for connecting and disconnecting the electrical load device(s) to and from the source of electrical power 22, and a reader 134 for reading the access information 130 from the readable access information device 124, the reader 134 being operably coupled with the switch device 132. Upon the reader 134 reading the access information 130 and determining that the access information 130 satisfies all of one or more preselected criteria, and if the electrical load device(s) 126 is disconnected from the source of electrical power 22, the reader 134 generates a connect signal that is transmitted to the switch device 132. Upon the switch device 132 receiving the connect signal, the switch device 132 connects the electrical load device(s) 126 to the source of electrical power 22. Upon the reader 134 determining that one or more of the preselected criteria are unsatisfied by the access information 130 while the electrical load device(s) 126 is connected to the source of electrical power 22, the reader 134 generates a disconnect signal that is transmitted to the switch device 132. Also, upon the switch device 132 receiving the disconnect signal, the switch device 132 disconnects the electrical load device(s) 126 from the source of electrical power 22.

The system 120 is for use where the electrical load device is “hardwired” to the source of electrical power, i.e., a substantially permanent connection is made between conductors. For example, the electrical load device 126 may be jets in a hot tub at a hotel. Because of the system 120, the jets in the hot tub are usable by a guest who has paid (or will pay, as the case may be) for such usage. As discussed above in connection with the access information 30 of the system 20, the access information 130 may include, for instance, time credit information, user identification information, or such other information as is desirable, depending on a preferred basis for control. The preferred basis for control may be, for example, time credit (i.e., a preauthorized time period paid for by the user in advance), user identification, or such other basis as is desirable or convenient, depending on the circumstances.

It will be understood that the reader 134 and the switch device 132 are to be located wherever convenient.

In one embodiment, upon the reader 134 determining that at least one of the preselected criteria is unsatisfied, and if the electrical load device is disconnected from the source of electrical power 22, the reader does not generate a signal for transmission to the switch device 132. In an alternative embodiment, if any one of the preselected criteria is unsatisfied by the access information 30, and if the electrical load device is disconnected from the source of electrical power, the reader generates the “non-connect” signal, which is transmitted to the switch device, resulting in the switch device not connecting the electrical load device to the source of electrical power.

As described above, if all of the preselected criteria are satisfied by the access information 30, and if the electrical load device is disconnected from the source of electrical power, then the reader generates the connect signal, which is transmitted to the switch device, and the switch device connects the electrical load device to the source of electrical power. In one embodiment, if the electrical load device is connected to the source of electrical power and the reader determines that all the preselected criteria are satisfied by the access information, then no signal is transmitted by the reader to the switch device. In an alternative embodiment, if the electrical load device is connected to the source of electrical power and the reader determines that all of the preselected criteria are satisfied by the access information, the reader generates a “non-disconnect” signal, which is transmitted to the switch device, causing the switch device to keep the electrical load device connected to the source of electrical power.

For example, in one embodiment, the access information preferably includes time credit information. Upon the reader 134 determining that the time credit information satisfies one or more preselected criteria in respect thereof (and all preselected criteria are otherwise satisfied), and if the electrical load device 126 is disconnected from the source of electrical power 22, the reader 134 generates the connect signal, which is transmitted to the switch device 132 for connection of the electrical load device 126 to the source of electrical power 22. Upon the reader 134 determining that one or more of the preselected criteria (including those in respect of the time credit information) are unsatisfied while the electrical load device 126 is connected to the source of electrical power 22, the reader 134 generates the disconnect signal, which is transmitted to the switch device 132 for disconnection of the electrical load device 126 from the source of electrical power 22.

In another alternative embodiment, in the system 120, the access information preferably includes user identification information. Upon the reader 134 determining that the user identification information satisfies one or more preselected criteria in respect thereof (and all preselected criteria are otherwise satisfied), and if the electrical load device 126 is disconnected from the source of electrical power 22, the reader 134 generates the connect signal, which is transmitted to the switch device 132 for connection of the electrical load device 126 to the source of electrical power 22. Also, upon the reader 134 determining that one or more of the preselected criteria (including those in respect of the user identification information) is unsatisfied while the electrical load device 126 is connected to the source of electrical power 22, the reader 134 generates the disconnect signal, which is transmitted to the switch device 132 for disconnection of the electrical load device 126 from the source of electrical power 22.

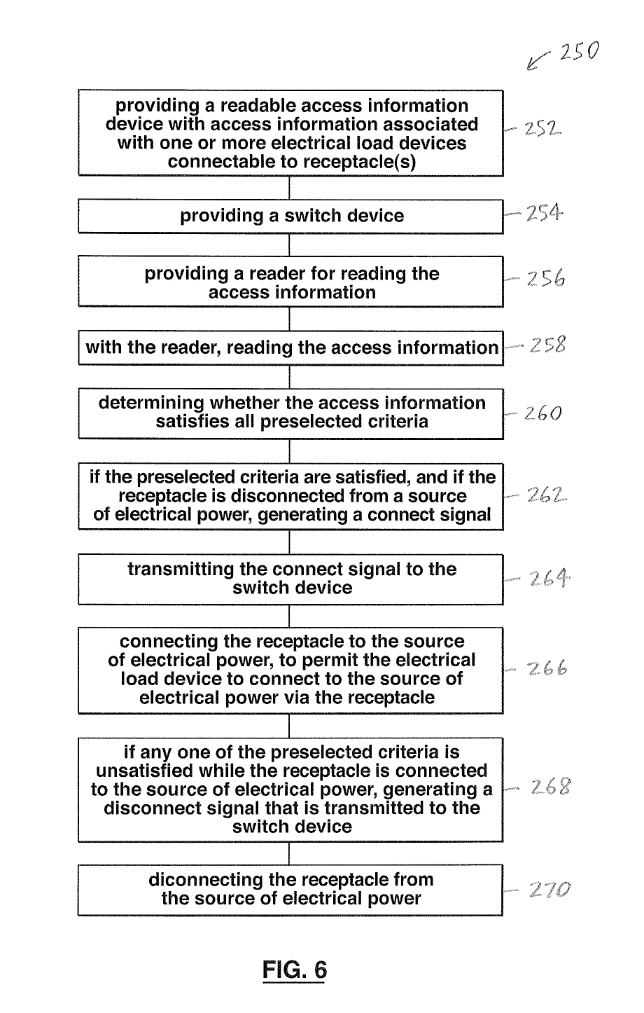

In use, an embodiment of a method 250 of the invention preferably includes the steps of, first, providing the readable access information device 24 associated with electrical load device(s) 26 electrically connectable to the receptacle(s) 28, the readable access information device 24 including access information (step 252, FIG. 6). Also, the switch device 32 for connecting and disconnecting the receptacle 28 to and from the source of electrical power 22 is provided (step 254). The reader 34 is provided, for reading the access information 30 from the readable access information device 24, the reader 34 being operably coupled to the switch device 32 (step 256). With the reader 34, the access information 30 from the readable access information device 24 is read (step 258). Next, it is determined whether the access information 30 satisfies all of the preselected criteria (step 260). If the access information satisfies all of the preselected criteria, and if the receptacle 28 is disconnected from the source of electrical power 22, then a connect signal is generated (step 262). Next, the connect signal is transmitted to the switch device 32 (step 264). With the switch device 32, the receptacle 28 is connected to the source of electrical power 22 upon the switch device 32 receiving the connect signal, to permit the electrical load device 26 to connect to the source of electrical power 22 via the receptacle 28 (step 266). If any one of the preselected criteria is unsatisfied by the access information 30 while the receptacle 28 is connected to the source of electrical power 22, a disconnect signal is generated that is transmitted to the switch device 32 (step 268). Upon the switch device 32 receiving the disconnect signal, the receptacle 28 is disconnected from the source of electrical power 22 (step 270).

It will be appreciated by those skilled in the art that, although certain steps are shown in FIG. 6 and described above as preceding certain other steps, the sequence in which certain of these steps is performed is not functionally significant. For example, any of steps 252, 254 and 256 could take place in any order relative to each other.

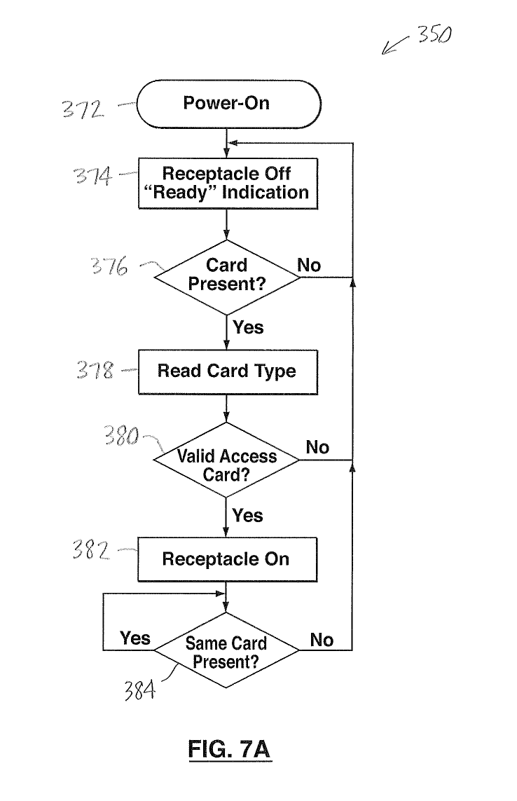

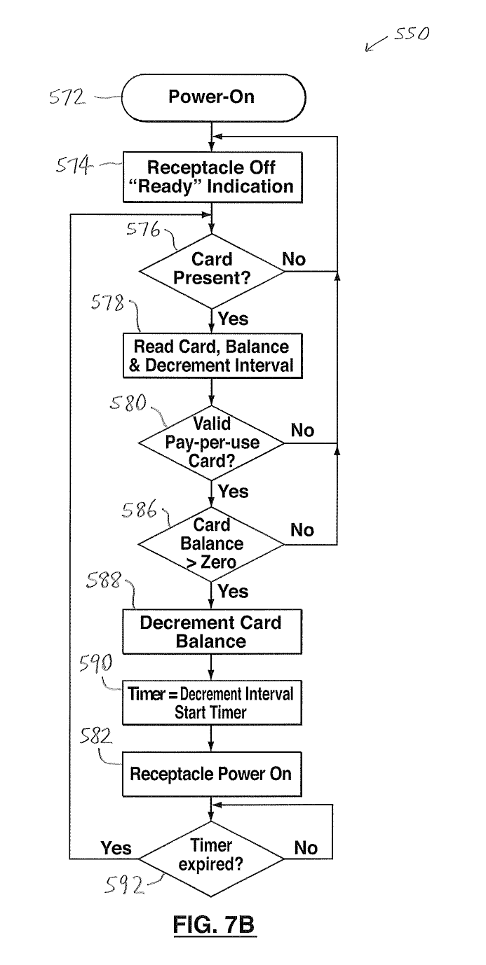

As described above, the reader 34 preferably reads the access information 30 at predetermined time intervals. As can be seen in FIG. 7A, in one embodiment, the process 350 of the invention includes, first, powering on (i.e., energizing the reader 34 (step 372, FIG. 7A). If the receptacle 28 is disconnected from the source of electrical power 22, then a small light 40 (FIG. 4A) provides a visual signal or indication to the user that indicates that the reader 34, and the receptacle 28, are ready for communication with the PCD tag (i.e., the readable access information device 24), to determine whether the receptacle 28 should be connected with the source of electrical power 22 (step 374). (As will be described, lights 40 may also visually indicate that a receptacle is not ready for connection to the source of electrical power.) In the next step, the reader 34 determines whether the readable access information device 24 is present (step 376). If it is, then in the next step, the reader 34 reads the readable access information device 24 (step 378). Next, the reader 34 determines whether the readable access information device 24 (referred to as an “access card” in FIG. 7A) is valid (step 380). If it is, then the receptacle 28 is connected to the source of electrical power 22 (step 382). However, if the readable access information device 24 is not recognized as validly authorizing the connection to the source of electrical power 22, then the receptacle is not so connected. In step 384, the reader 34 checks, preferably at relatively small time intervals, to determine whether the previously (or initially) authorized readable access information device 24 is still present. If not, then the reader 34 causes the receptacle 28 to be disconnected from the source of electrical power.

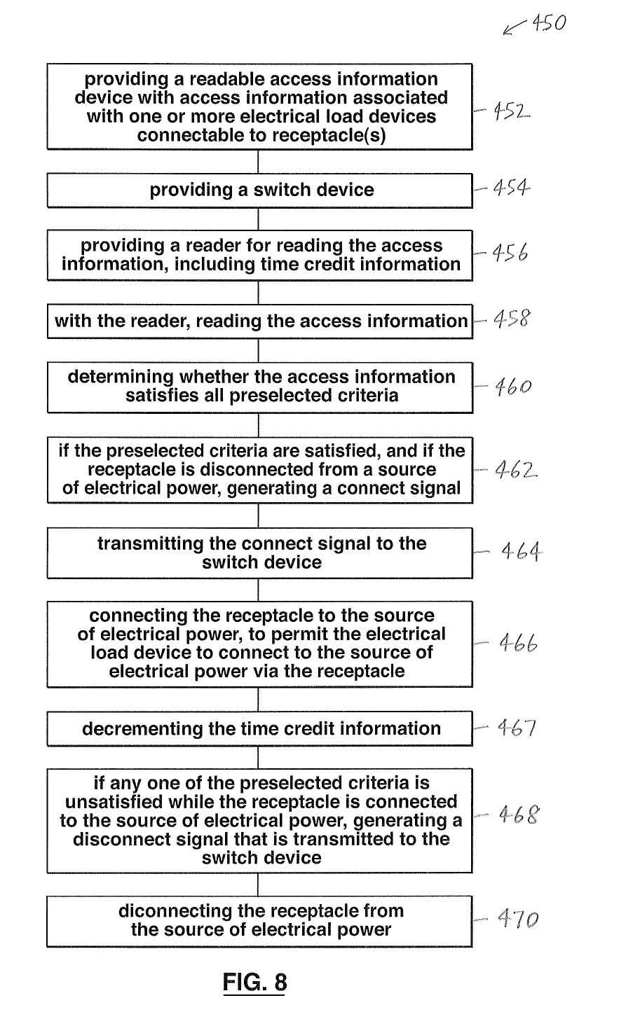

As described above, in one embodiment, the access information 30 preferably includes time credit information. The method 450 of the invention, schematically illustrated in FIG. 8, preferably includes, first, providing the readable access information device 24 associated with one or more electrical load devices 26 electrically connectable to one or more receptacles 28, the readable access information device 24 including access information 30 having time credit information which authorizes connecting the receptacle to the source of electrical power 22 for up to a preauthorized time period (step 452, FIG. 8). Also, the switch device 32 is provided, for connecting and disconnecting the receptacle 28 to and from the source of electrical power 22 (step 454). The reader 34 is provided for reading the access information 30 from the readable access information device 24, the reader 34 being operably coupled to the switch device 32 (step 456). With the reader 34, the access information 30 is read from the readable access information device 24 (step 458). Next, it is determined whether the access information satisfies a plurality of preselected criteria (step 460). If the access information satisfies all of the preselected criteria, and if the receptacle 28 is disconnected from the source of electrical power, a connect signal is generated (step 462). The connect signal is transmitted to the switch device (step 464). With the switch device 32, the receptacle 28 is connected to the source of electrical power 22 upon the switch device receiving the connect signal, to permit the electrical load device 26 to connect to the source of electrical power 22 via the receptacle 28 (step 466). Next, the time credit information is decremented in preselected time decrement intervals while the receptacle 28 is connected to the source of electrical power 22, to decrease the preauthorized time period by the decremented time decrement intervals (step 467). If one or more of the preselected criteria are unsatisfied by the access information while the receptacle is connected to the source of electrical power, a disconnect signal is generated, that is transmitted to the switch device (step 468). Upon the switch device receiving the disconnect signal, the receptacle is disconnected from the source of electrical power (step 470).

It will be appreciated by those skilled in the art that, although certain steps are shown in FIG. 8 and described above as preceding certain other steps, the sequence in which certain of the steps is performed is not functionally significant. For example, any of steps 452, 454, and 456 could take place in any order relative to each other.

In one embodiment, the reader 34 preferably reads the access information 30 at decrement intervals. As illustrated in FIG. 7B, in one embodiment, the process 550 of the invention includes, first, powering on (i.e., energizing the reader 34) (step 572, FIG. 7B). If the receptacle 28 is disconnected from the source of electrical power 22, then the small light 40 (FIG. 4A) provides the visual signal or indication to the user that indicates that the reader 34, and the receptacle 28, are ready for communication with the PCD tag (i.e., the reader will access information device 24), to determine whether the receptacle 28 should be connected with the source of electrical power 22 (step 574). In the next step, the reader 34 determines whether the readable access information device 24 is present (step 576). If it is, then in the next step, the reader 34 reads the access information 30 in the readable access information device 24 (step 578). Preferably, in this step, the reader determines the balance of the preauthorized time period remaining, as well as the applicable decrement interval for the time credit information, in the access information.

It will be understood that, in practice, data related to other parameters in the access information (e.g., a group code), is also read, if present. For clarity of illustration, references to other parameters are omitted from FIG. 7B.

The decrement interval is the time period by which the preauthorized time period is decremented. The decrement interval preferably is any suitable time interval, selected based on the circumstances in which the time credits are to be utilized. For instance, where the readable access information device 24 is included in or mounted onto the plug 36, the decrement interval may be one minute. Preferably, the reader includes a timer that is set to equal the decrement interval. As can be seen in FIG. 7B, this means that, after one minute has expired, the reader checks to determine that the access information is still present (step 576). As will be described, where the PCD tag is provided in the form of a command card or key fob, it is preferred that the decrement interval is longer, e.g., 30 minutes.

As can be seen in FIG. 7B, the reader 34 next determines whether the access information in the readable access information device 24 (referred to as a “card” in FIG. 7B) is valid (step 580). If the access information is valid (e.g., if the group code matches an authorized group code in the reader's memory), then the reader determines whether the card balance (i.e., the balance of the preauthorized time period remaining) is greater than zero (step 586). If it is, then the reader decrements the card balance, by the decrement interval (step 588). In step 590, the timer is started. As noted above, the decrement interval preferably determines the time limit set by the timer. Also, on or about the time when the preauthorized time period is decremented, the receptacle 28 is connected to the source of electrical power 22 (step 582). While the timer has not expired, the receptacle remains connected. When the timer expires (i.e., if the decrement interval expires) (step 592), then the reader checks to determine whether the access information is present and readable, and also whether the preselected criteria are still satisfied (steps 576, 578, 580). If so, and if the balance of the preauthorized time period remaining is greater than zero (step 586), then the reader proceeds with the next steps (588, 590, 592) to connect the receptacle. However, as can be seen from the foregoing, if the access information 30 fails to meet any of the preselected criteria (step 580), then the receptacle is disconnected. (As described above, connection and disconnection of the receptacle are effected by the switch device in response to signals. For the purposes of illustration, the details of connection and disconnection have been omitted from FIG. 7B).

If the decrement interval is one minute, then, as described above, the result is that the timer “times out” once a minute, and the reader 34 checks (in steps 576, 578, 580) to determine whether the preselected criteria are satisfied. As noted above, this may be convenient where, e.g., the readable access information device 24 is mounted in or on the plug 36 of the electrical load device. In these circumstances, it is preferred that the decrement interval is relatively short because of the risk that an unauthorized user may attempt to connect via a receptacle which has been connected.

In another embodiment, the decrement interval may be set at a longer time period, e.g., 30 minutes. This relatively long decrement interval is preferred, for example, where the readable access information device 24 is included in the command card or key fob 38. For instance, the card 38 may be purchased for one-time use, and disposable. The longer decrement interval is preferred for the user's convenience, i.e., the user only needs to position the card near the receptacle once every 30 minutes, in order to re-connect to the source of electrical power.

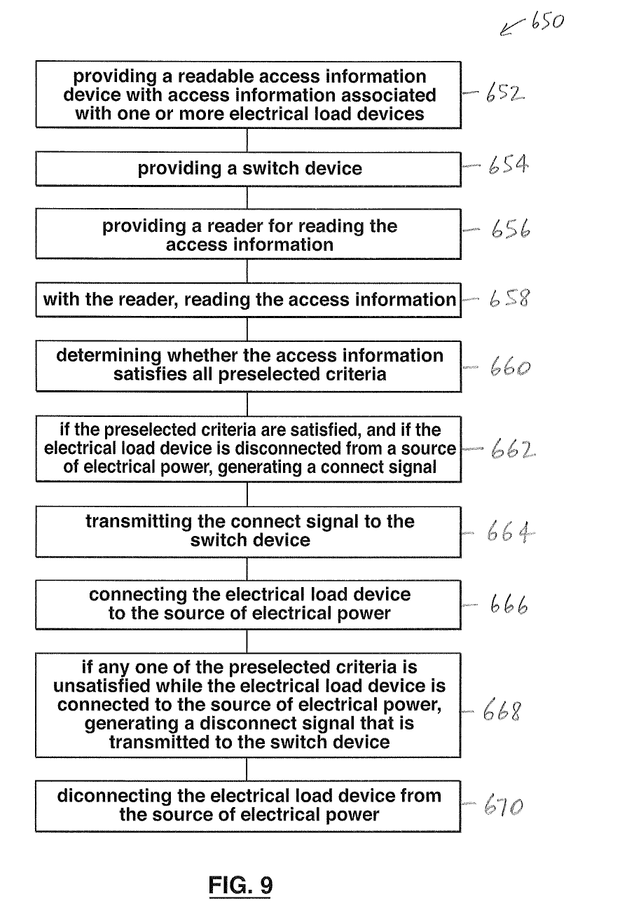

In another embodiment of the method 650 of the invention, first, the readable access information device 124 associated with one or more electrical load devices 126 is provided, the readable access information device including access information (step 652, FIG. 9). Also, the switch device 132 is provided for connecting and disconnecting the electrical load device 126 to and from the source of electrical power 22 (step 654). In addition, the reader 134 is provided for reading the access information from the readable access information device 124, the reader being operably coupled with the switch device (step 656). With the reader, the access information 130 from the readable access information device 124 is read (step 658). Next, it is determined whether the access information satisfies one or more preselected criteria (step 660). If the access information satisfies the preselected criteria, and if the electrical load device is disconnected from the source of electrical power, a connect signal is generated (step 662). The connect signal is generated to the switch device (step 664). With the switch device, the electrical load device is connected to the source of electrical power (step 666). If any one of the preselected criteria is unsatisfied by the access information while the electrical load device is connected to the source of electrical power, a disconnect signal is generated that is transmitted to the switch device (step 668). Upon the switch device receiving the disconnect signal, the electrical load device is disconnected from the source of electrical power (step 670).

It will be appreciated by those skilled in the art that, although certain steps are shown in FIG. 9 and described above as preceding certain other steps, the sequence in which certain of the steps is performed is not functionally significant. For example, any of steps 652, 654, and 656 could take place in any order relative to each other.

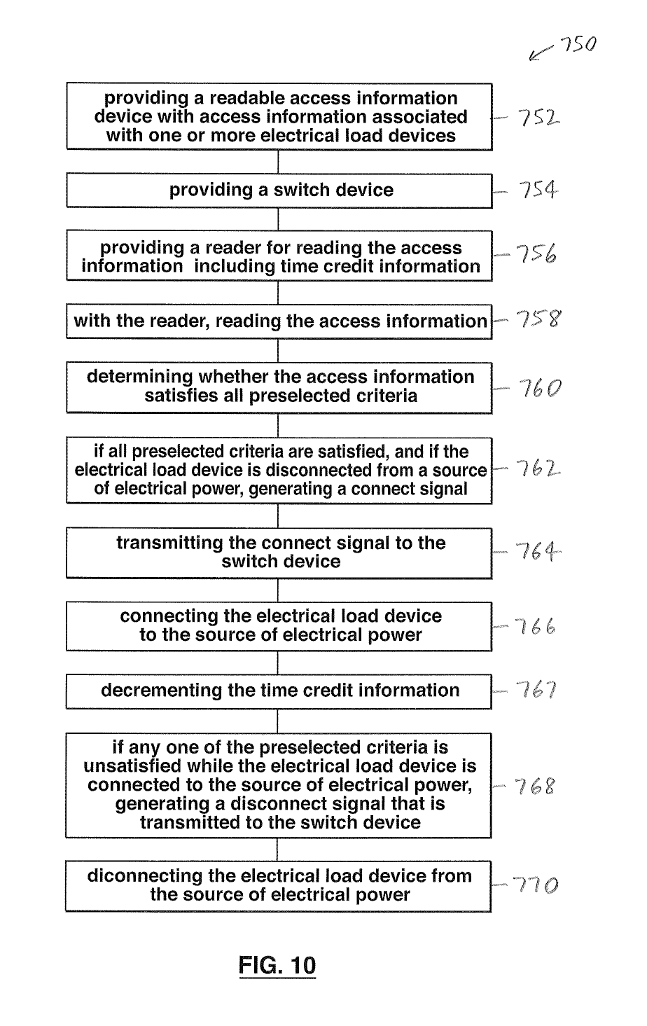

Another embodiment of the method 750 of the invention is schematically illustrated in FIG. 10. In this method, first, the readable access information device 124 associated with one or more electrical load devices 126 is provided, the readable access information device 124 including access information 130 having time credit information which authorizes connecting the electrical load device to the source of electrical power 22 for up to a preauthorized time period (step 752, FIG. 10). Also, the switch device 132 is provided for connecting and disconnecting the electrical load device 126 to and from the source of electrical power (step 754). The reader 134 is provided for reading the access information 130 from the readable access information device 124, the reader 134 being operably coupled with the switch device 132 (step 756). With the reader, the access information is read from the readable access information device (step 758). Next, it is determined whether the access information satisfies a plurality of preselected criteria (step 760). If the access information satisfies all of the preselected criteria, and if the electrical load device is disconnected from the source of electrical power, a connect signal is generated (step 762). The connect signal is transmitted to the switch device (step 764). With the switch device, the electrical load device is connected to the source of electrical power (step 766). The time credit information is decremented in preselected time decrement intervals while the electrical load device is connected to the source of electrical power, to decrease the preauthorized time period by the decremented time decrement intervals (step 767). If one or more of the preselected criteria is not satisfied by the access information while the electrical load device is connected to the source of electrical power, a disconnect signal is generated that is transmitted to the switch device (step 768). Upon the switch device receiving the disconnect signal, the electrical load device is disconnected from the source of electrical power (step 770).

It will be appreciated by those skilled in the art that, although certain steps are shown in FIG. 10 and described above as preceding certain other steps, the sequence in which certain of the steps is performed is not functionally significant. For example, any of steps 752, 754, and 756 could take place in any order relative to each other.

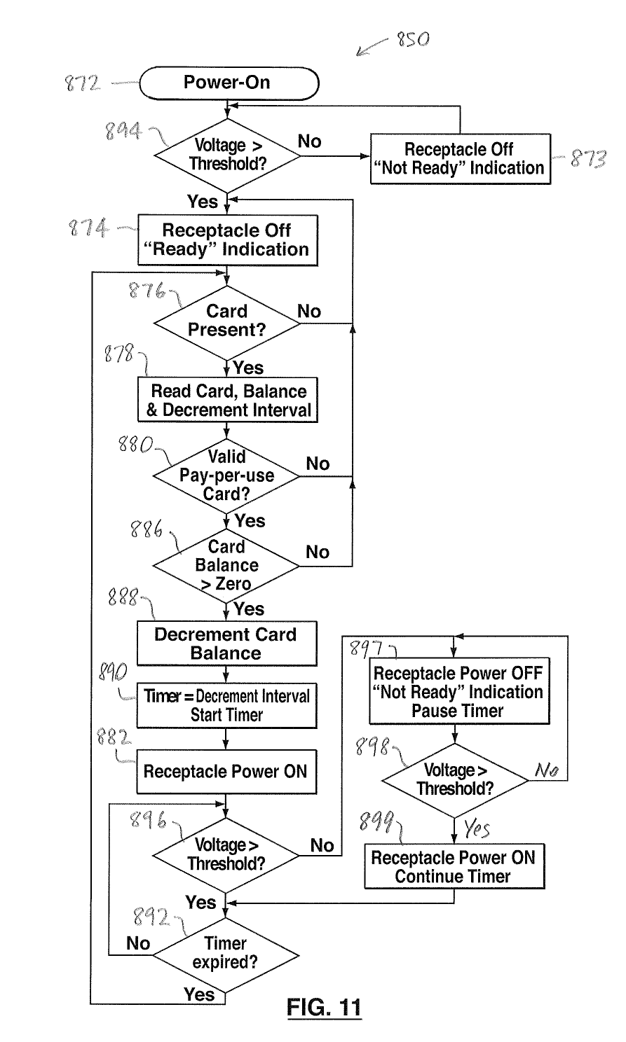

As described above, in one embodiment, the method of the invention includes determining whether one or more preselected characteristics of the electrical power provided by the source of electrical power 22 is within certain parameters. For example, one such preselected characteristic is line voltage. In an embodiment of the method 850 of the invention schematically illustrated in FIG. 11, the process begins with the step of powering on (i.e., energizing the reader 34) (step 872, FIG. 11). Next, the line voltage is measured, to determine whether it is above a threshold minimum voltage (step 894). If it is, then a visual indication is given that the receptacle is ready for connection (step 874), it being understood that the receptacle is at this point disconnected from the source of electrical power 22. However, if the line voltage is not greater than the minimum threshold, then a visual indication is given that the receptacle is not ready for connection (step 873). For instance, one or more lights may be provided at the receptacle (e.g., light 40, shown in FIG. 4A) and adapted to provide the visual indications, e.g., a green light indicating that the receptacle is ready for connection, and a red light indicating that the receptacle is not ready for connection.

Next, the reader 34 determines whether the readable access information device 24 is present (step 876). If it is, then in the next step, the reader 34 reads the readable access information device 24 (step 878). Preferably, in this step, the reader determines the balance of the preauthorized time period remaining, as well as the applicable decrement time interval for the time credit information, in the access information.

As will be described, in this embodiment, the access information preferably also includes a preselected characteristic of the electrical power provided by the source of electrical power, i.e., line voltage. It will be understood that, in practice, data related to other parameters in the access information (e.g., a group code) is also read, if present. For clarity of illustration, references to other parameters are omitted from FIG. 11.

As described above, the decrement interval is the time period by which the preauthorized time period is decremented, and the decrement interval preferably is any suitable time interval, selected based on the circumstances in which the time credits are to be utilized. For instance, where the readable access information device 24 is included in or mounted onto the plug 36, the decrement interval may be one minute. Preferably, the reader includes a timer that is set to equal the decrement interval. As can be seen in FIG. 11, this means that, after one minute has expired, the reader checks to determine that the access information is still present (step 876). As will be described, where the PCD tag is provided in the form of a command card or key fob, it is preferred that the decrement interval is longer, e.g., 30 minutes.

As can be seen in FIG. 11, the reader 34 next determines whether the access information in the readable access information device 24 (referred to as a “card” in FIG. 11) is valid (step 880). If the access information is valid (e.g., if the group code matches an authorized group code in the reader's memory), then the reader determines whether the card balance (i.e., the balance of the preauthorized time period remaining) is greater than zero (step 886). If it is, then the reader decrements the card balance, by the decrement interval (step 888). In step 890, the timer is started. As noted above, the decrement interval preferably determines the time limit set by the timer. Also, on or about the time when the preauthorized time period is decremented, the receptacle 28 is connected to the source of electrical power 22 (step 882).

Once the receptacle is connected, the line voltage is measured, to determine whether it is above the minimum threshold voltage (step 896). As can be seen in FIG. 11, if, in step 896, the line voltage is determined to be below the minimum threshold voltage, then the receptacle is disconnected, and a “not ready” indication is provided (step 897). (This indication preferably is a visual indication, provided by a light at the receptacle, as described above.) At this point, the timer is also paused, i.e., the card balance is not decremented. After a predetermined time interval, the line voltage is checked again (step 898), to determine whether it is above the minimum threshold voltage. If it is, then the receptacle is connected to the source of electrical power, and the timer is re-started (i.e., the card balance is decremented) (step 899).

If, in step 898, the line voltage is determined to be below the minimum threshold voltage, then the receptacle remains disconnected from the source of electrical power. As indicated by the loop in FIG. 11, in this situation, the reader will continue to check the line voltage at the predetermined time interval to determine whether the line voltage is above the minimum threshold voltage.

If the voltage is checked and found to be above the minimum threshold voltage, then the receptacle is connected (steps 896, 899). While the timer has not expired, the receptacle remains connected. When the timer expires (i.e., if the decrement interval expires) (step 892), then the reader checks to determine whether the access information is present and readable, and also whether the preselected criteria are still satisfied (steps 876, 878, 880). If so, and if the balance of the preauthorized time period remaining is greater than zero (step 886), then the reader proceeds with the next steps (888, 890, 882) to connect the receptacle. However, as can be seen from the foregoing, if the access information 30 fails to meet any of the preselected criteria (step 880), then the receptacle is disconnected. (As described above, connection and disconnection of the receptacle are effected by the switch device in response to signals. For the purposes of illustration, the details of connection and disconnection have been omitted from FIG. 11.)

It will be appreciated by those skilled in the art that the invention can take many forms, and that such forms are within the scope of the invention as described above. The foregoing descriptions are exemplary, and their scope should not be limited to the preferred versions provided therein.

We claim:

1. A system for controlling access to a source of electrical power, the system comprising:
a readable access information device associated with at least one electrical load device electrically connectable to at least one receptacle, the readable access information device comprising access information;
a switch device for connecting and disconnecting said at least one receptacle to and from the source of electrical power;
a reader for reading the access information from the readable access information device, the reader being operably coupled with the switch device;
upon the reader reading the access information and determining that the access information satisfies at least one preselected criterion, and if said at least one receptacle is disconnected from the source of electrical power, the reader generating a connect signal that is transmitted to the switch device;
upon the switch device receiving the connect signal, the switch device connecting said at least one receptacle to the source of electrical power, to permit said at least one electrical load device to connect to the source of electrical power via said at least one receptacle;
upon the reader determining that said at least one preselected criterion is unsatisfied by the access information while said at least one receptacle is connected to the source of electrical power, the reader generating a disconnect signal that is transmitted to the switch device; and
upon the switch device receiving the disconnect signal, the switch device disconnecting said at least one receptacle from the source of electrical power.

2. A system according to claim 1 in which, upon the reader determining that said at least one preselected criterion is unsatisfied, and if said at least one receptacle is disconnected from the source of electrical power, no signal is generated by the reader for transmission to the switch device.

3. A system according to claim 2 in which:
the reader reads the access information at predetermined time intervals to determine, at the predetermined time intervals, whether the access information satisfies said at least one preselected criterion;
upon the reader determining that the access information satisfies said at least one preselected criterion, and if said at least one receptacle is disconnected from the source of electrical power, the reader generates the connect signal, which is transmitted to the switch device for connection of said at least one receptacle to the source of electrical power; and
upon the reader determining that said at least one preselected criterion is unsatisfied by the access information while said at least one receptacle is connected to the source of electrical power, the reader generates the disconnect signal, which is transmitted to the switch device for disconnection of said at least one receptacle from the source of electrical power.

4. A system according to claim 3 in which:
the access information comprises time credit information;
upon the reader determining that the time credit information satisfies at least one preselected criterion in respect thereof, and if said at least one receptacle is disconnected from the source of electrical power, the reader generates the connect signal, which is transmitted to the switch device for connection of said at least one receptacle to the source of electrical power; and
upon the reader determining that said at least one preselected criterion in respect of the time credit information is unsatisfied while said at least one receptacle is connected to the source of electrical power, the reader generates the disconnect signal, which is transmitted to the switch device for disconnection of said at least one receptacle from the source of electrical power.

5. A system according to claim 4 in which:
the time credit information authorizes connecting said at least one receptacle to the source of electrical power for up to a preauthorized time period while said at least one preselected criterion is satisfied; and
the reader decrements the time credit information in preselected time decrement intervals while said at least one receptacle is connected to the source of electrical power, to decrease the preauthorized time period by the decremented time decrement intervals.

6. A system according to claim 2 in which:
the access information comprises time credit information for authorizing connection of said at least one receptacle to the source of electrical power for up to a preauthorized time period;
upon the reader determining that the time credit information satisfies at least one preselected criterion in respect of the time credit information, and if said at least one receptacle is disconnected from the source of electrical power, the reader generates the connect signal, which is transmitted to the switch device for connection of said at least one receptacle to the source of electrical power for up to the preauthorized time period;
while said at least one receptacle is connected to the source of electrical power, the reader decrements the preauthorized time period in preselected time decrement intervals, to decrease the preauthorized time period by the decremented time decrement intervals; and
upon the expiry of the preauthorized time period while said at least one receptacle is connected to the source of electrical power, the reader determines that said at least one preselected criterion in respect of the time credit information is unsatisfied, and the reader generates the disconnect signal, which is transmitted to the switch device for disconnection of said at least one receptacle from the source of electrical power.

7. A system according to claim 3 in which:
the access information comprises a unique address associated with said at least one electrical load device;
upon the reader determining that the unique address satisfies at least one preselected criterion in respect thereof, and if said at least one receptacle is disconnected from the source of electrical power, the reader generates the connect signal, which is transmitted to the switch device for connection of said at least one receptacle to the source of electrical power; and
upon the reader determining that said at least one preselected criterion in respect of the unique address is unsatisfied while said at least one receptacle is connected to the source of electrical power, the reader generates the disconnect signal, which is transmitted to the switch device for disconnection of said at least one receptacle from the source of electrical power.

8. A system according to claim 3 in which:
the access information comprises at least one group code associated with said at least one electrical load device;
upon the reader determining that said at least one group code satisfies at least one preselected criterion in respect thereof, and if said at least one receptacle is disconnected from the source of electrical power, the reader generates the connect signal, which is transmitted to the switch device for connection of said at least one receptacle to the source of electrical power; and
upon the reader determining that said at least one preselected criterion in respect of said at least one group code is unsatisfied while said at least one receptacle is connected to the source of electrical power, the reader generates the disconnect signal, which is transmitted to the switch device for disconnection of said at least one receptacle from the source of electrical power.

9. A system according to claim 3 in which:
the access information comprises user identification information for authorizing connection of said at least one receptacle to the source of electrical power for an authorized user;
upon the reader determining that the user identification information satisfies at least one preselected criterion in respect thereof, and if said at least one receptacle is disconnected from the source of electrical power, the reader generates the connect signal, which is transmitted to the switch device for connection of said at least one receptacle to the source of electrical power; and
upon the reader determining that said at least one preselected criterion in respect of the user identification information is unsatisfied while said at least one receptacle is connected to the source of electrical power, the reader generates the disconnect signal and transmits the disconnect signal to the switch device for disconnection of said at least one receptacle from the source of electrical power.

10. A system according to claim 3 in which:
the access information comprises at least one preselected characteristic of electrical power provided by the source of electrical power;
upon the reader determining that said at least one preselected characteristic satisfies said at least one preselected criterion in respect thereof, and if said at least one receptacle is disconnected from the source of electrical power, the reader generates and transmits the connect signal for connection of said at least one receptacle to the source of electrical power; and
upon the reader determining that said at least one preselected criterion in respect of said at least one preselected characteristic of electrical power is unsatisfied while said at least one receptacle is connected to the source of electrical power, the reader generates the disconnect signal and transmits the disconnect signal to the switch device for disconnection of said at least one receptacle from the source of electrical power.

11. A system according to claim 10 in which said at least one preselected characteristic is a line voltage associated with the electrical power provided by the source of electrical power at said at least one receptacle.

12. A system for controlling access to a source of electrical power, the system comprising:
a readable access information device associated with at least one electrical load device, the readable access information device comprising access information;
a switch device for connecting and disconnecting said at least one electrical load device to and from the source of electrical power;
a reader for reading the access information from the readable access information device, the reader being operably coupled with the switch device;
upon the reader reading the access information and determining that the access information satisfies at least one preselected criterion, and if said at least one electrical load device is disconnected from the source of electrical power, the reader generating a connect signal that is transmitted to the switch device;
upon the switch device receiving the connect signal, the switch device connecting said at least one electrical load device to the source of electrical power;
upon the reader determining that said at least one preselected criterion is unsatisfied by the access information while said at least one electrical load device is connected to the source of electrical power, the reader generating a disconnect signal that is transmitted to the switch device; and
upon the switch device receiving the disconnect signal, the switch device disconnecting said at least one electrical load device from the source of electrical power.

13. A system according to claim 12 in which, upon the reader determining that said at least one preselected criterion is unsatisfied, and if said at least one electrical load device is disconnected from the source of electrical power, no signal is generated by the reader for transmission to the switch device.

14. A system according to claim 13 in which:
the access information comprises time credit information;
upon the reader determining that the time credit information satisfies at least one preselected criterion in respect thereof, and if said at least one electrical load device is disconnected from the source of electrical power, the reader generates the connect signal, which is transmitted to the switch device for connection of said at least one electrical load device to the source of electrical power; and
upon the reader determining that said at least one preselected criterion in respect of the time credit information is unsatisfied while said at least one electrical load device is connected to the source of electrical power, the reader generates the disconnect signal, which is transmitted to the switch device for disconnection of said at least one electrical load device from the source of electrical power.

15. A system according to claim 13 in which:
the access information comprises user identification information;
upon the reader determining that the user identification information satisfies at least one preselected criterion in respect thereof, and if said at least one electrical load device is disconnected from the source of electrical power, the reader generates the connect signal, which is transmitted to the switch device for connection of said at least one electrical load device to the source of electrical power; and
upon the reader determining that said at least one preselected criterion in respect of the user identification information is unsatisfied while said at least one electrical load device is connected to the source of electrical power, the reader generates the disconnect signal, which is transmitted to the switch device for disconnection of said at least one electrical load device from the source of electrical power.

16. A method of controlling access to a source of electrical power, the method comprising the steps of:
(a) providing a readable access information device associated with at least one electrical load device electrically connectable to at least one receptacle, the readable access information device comprising access information;
(b) providing a switch device for connecting and disconnecting said at least one receptacle to and from the source of electrical power;
(c) providing a reader for reading the access information from the readable access information device, the reader being operably coupled to the switch device;
(d) with the reader, reading the access information from the readable access information device;
(e) determining whether the access information satisfies at least one preselected criterion;
(f) if the access information satisfies said at least one preselected criterion, and if said at least one receptacle is disconnected from the source of electrical power, generating a connect signal;
(g) transmitting the connect signal to the switch device;
(h) with the switch device, connecting said at least one receptacle to the source of electrical power upon the switch device receiving the connect signal, to permit said at least one electrical load device to connect to the source of electrical power via said at least one receptacle;
(i) if said at least one preselected criterion is unsatisfied by the access information while said at least one receptacle is connected to the source of electrical power, generating a disconnect signal that is transmitted to the switch device; and
(j) upon the switch device receiving the disconnect signal, disconnecting said at least one receptacle from the source of electrical power.

17. A method according to claim 16 in which, in step (d), the reader reads the access information at predetermined time intervals.

18. A method according to claim 17 in which the access information comprises time credit information.

19. A method of controlling access to a source of electrical power, the method comprising the steps of:
(a) providing a readable access information device associated with at least one electrical load device electrically connectable to at least one receptacle, the readable access information device comprising access information comprising time credit information which authorizes connecting said at least one receptacle to the source of electrical power for up to a preauthorized time period;
(b) providing a switch device for connecting and disconnecting said at least one receptacle to and from the source of electrical power;
(c) providing a reader for reading the access information from the readable access information device, the reader being operably coupled to the switch device;
(d) with the reader, reading the access information from the readable access information device;
(e) determining whether the access information satisfies a plurality of preselected criteria;
(f) if the access information satisfies all of the preselected criteria, and if said at least one receptacle is disconnected from the source of electrical power, generating a connect signal;
(g) transmitting the connect signal to the switch device;
(h) with the switch device, connecting said at least one receptacle to the source of electrical power upon the switch device receiving the connect signal, to permit said at least one electrical load device to connect to the source of electrical power via said at least one receptacle;
(i) decrementing the time credit information in preselected time decrement intervals while said at least one receptacle is connected to the source of electrical power, to decrease the preauthorized time period by the decremented time decrement intervals;
(j) if at least one of the preselected criteria is unsatisfied by the access information while said at least one receptacle is connected to the source of electrical power, generating a disconnect signal that is transmitted to the switch device; and
(k) upon the switch device receiving the disconnect signal, disconnecting said at least one receptacle from the source of electrical power.

20. A method of controlling access to a source of electrical power, the method comprising the steps of:
(a) providing a readable access information device associated with said at least one electrical load device, the readable access information device comprising access information;
(b) providing a switch device for connecting and disconnecting said at least one electrical load device to and from the source of electrical power;
(c) providing a reader for reading the access information from the readable access information device, the reader being operably coupled with the switch device;
(d) with the reader, reading the access information from the readable access information device;
(e) determining whether the access information satisfies at least one preselected criterion;
(f) if the access information satisfies said at least one preselected criterion, and if said at least one electrical load device is disconnected from the source of electrical power, generating a connect signal;
(g) transmitting the connect signal to the switch device;
(h) with the switch device, connecting said at least one electrical load device to the source of electrical power;
(i) if said at least one preselected criterion is unsatisfied by the access information while said at least one electrical load device is connected to the source of electrical power, generating a disconnect signal that is transmitted to the switch device; and
(j) upon the switch device receiving the disconnect signal, disconnecting said at least one electrical load device from the source of electrical power.

21. A method of controlling access to a source of electrical power, the method comprising the steps of:
(a) providing a readable access information device associated with said at least one electrical load device, the readable access information device comprising access information comprising time credit information which authorizes connecting said at least one electrical load device to the source of electrical power for up to a preauthorized time period;
(b) providing a switch device for connecting and disconnecting said at least one electrical load device to and from the source of electrical power;
(c) providing a reader for reading the access information from the readable access information device, the reader being operably coupled with the switch device;
(d) with the reader, reading the access information from the readable access information device;
(e) determining whether the access information satisfies a plurality of preselected criteria;
(f) if the access information satisfies all of the preselected criteria, and if said at least one electrical load device is disconnected from the source of electrical power, generating a connect signal;
(g) transmitting the connect signal to the switch device;
(h) with the switch device, connecting said at least one electrical load device to the source of electrical power;
(i) decrementing the time credit information in preselected time decrement intervals while said at least one electrical load device is connected to the source of electrical power, to decrease the preauthorized time period by the decremented time decrement intervals;
(j) if at least one of the preselected criteria is unsatisfied by the access information while said at least one electrical load device is connected to the source of electrical power, generating a disconnect signal that is transmitted to the switch device; and
(k) upon the switch device receiving the disconnect signal, disconnecting said at least one electrical load device from the source of electrical power.
